(19) United States
(12) Patent Application Publication
(10) Pub. No.: US 2022/0101468 A1
(43) Pub. Date: Mar. 31, 2022

(54) METHOD FOR AUTOMATICALLY MANAGING ON-STREET PARKING

(71) Applicant: Auto Park Hawaii, Inc., Honolulu, HI (US)

(72) Inventors: John Lyles, Honolulu, HI (US); Fred Moore, Honolulu, HI (US)

(21) Appl. No.: 17/470,276

(22) Filed: Sep. 9, 2021

Related U.S. Application Data
(60) Provisional application No. 63/076,256, filed on Sep. 9, 2020.
(60) Provisional application No. 63/117,410, filed on Nov. 23, 2020.

(51) Int. Cl. G06Q 50/26

(52) U.S. Cl. CPC G06Q 50/26; G06Q 2240/00

(57) ABSTRACT

One variation of a method can be implemented by a computer system (e.g., a computer network, a remote server, a local parking enforcement kiosk) in cooperation with a set of sensor units installed below restricted parking spaces (e.g., loading zones, freight parking spaces) and vehicle transmitters installed in authorized vehicles (e.g., delivery vehicles, commercial vehicles) to automatically enforce parking rules in restricted parking spaces, such as including: parking time limits; grace periods for unauthorized vehicles; billing rates for authorized vehicles; and issuance of citations for unauthorized vehicles occupying such parking spaces beyond the grace period.

### CROSS-REFERENCE TO RELATED APPLICATIONS

This Application claims the benefit of U.S. Provisional Application Nos. 63/076,256, filed on 9 Sep. 2020, and 63/117,410, filed on 23 Nov. 2020, each of which are incorporated in their entireties by this reference.

### TECHNICAL FIELD

This invention relates generally to the field of vehicle parking systems and more specifically to a new and useful method for automatically managing on-street parking in the field of vehicle parking systems.

### BRIEF DESCRIPTION OF THE FIGURES

FIG. 1 is a flowchart representation of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

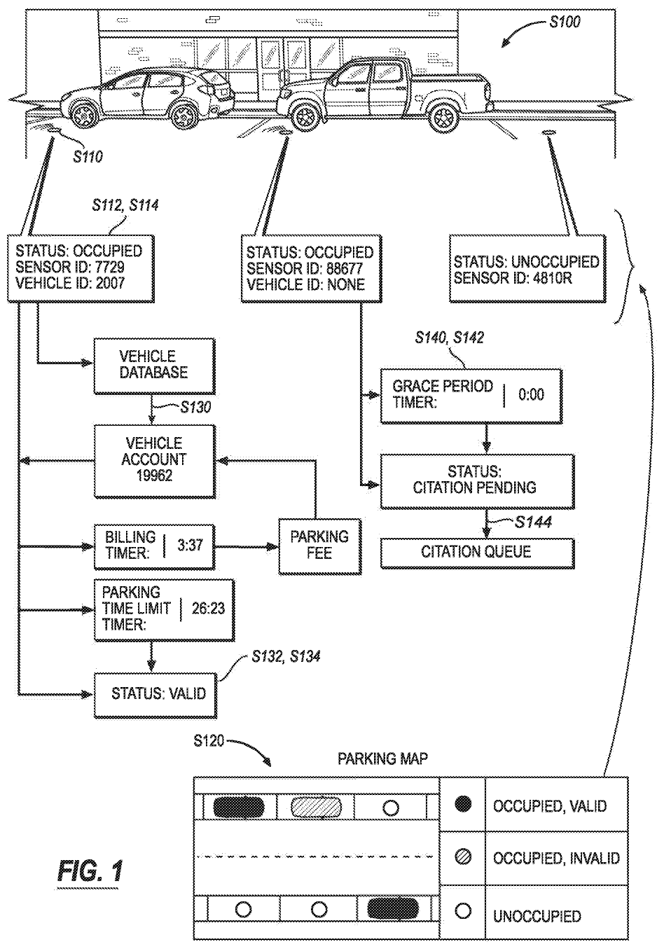

As shown in FIG. 1, a method for automatically managing on-street parking includes, at a sensor unit located under a parking space: in response to detecting an overhead mass, broadcasting a query in Block S110 and transmitting a status update for occupancy of the parking space to a computer system in Block S112; and, in response to receiving a vehicle identifier from a vehicle transmitter responsive to broadcasting the query, transmitting the vehicle identifier to the computer system in Block S114.

The method S100 also includes, at the computer system: in response to receiving the status update for occupancy of the parking space: updating a representation of the parking space in a parking space map according to the status update for occupancy of the parking space in Block S120; and, in response to receiving the vehicle identifier from the sensor unit, identifying a vehicle account associated with the vehicle identifier in Block S130, retrieving a parking time limit assigned to the parking space in Block S132, initiating a parking timer for the parking time limit in Block S134, and transmitting a notification for parking infringement by a vehicle associated with the vehicle identifier to the vehicle account in response to expiration of the parking timer prior to receipt of a status update for availability of the parking space from the sensor unit in Block S136.

The method S100 further includes, at the computer system, in response to absence of a receipt of the vehicle identifier from the sensor unit: retrieving a grace period duration assigned to the parking space in Block S140; initiating a grace period timer for the grace period duration in Block S142; and dispatching parking enforcement personnel to issue a citation at the parking space in Block S144 in response to expiration of the grace period timer prior to receipt of a status update for availability of the parking space from the sensor unit.

### 2. Applications

Generally, the method S100 can be implemented by a computer system (e.g., a computer network, a remote server, a local parking enforcement kiosk) in cooperation with a set of sensor units installed below restricted parking spaces (e.g., loading zones, freight parking spaces) and vehicle transmitters installed in authorized vehicles (e.g., delivery vehicles, commercial vehicles) to automatically enforce parking rules in restricted parking spaces, such as including: parking time limits; grace periods for unauthorized vehicles; billing rates for authorized vehicles; and issuance of citations for unauthorized vehicles occupying such parking spaces beyond the grace period.

The computer system can also execute Blocks of the method S100: to populate a map of parking spaces within a geographic region with statuses of these restricted parking spaces; to host a user portal (e.g., with a native application or web browser) to enable drivers to view this map and thus track statuses of parking spaces near their destinations; to enable these drivers to place “holds” on these parking spaces while en route to their destinations; and to enforce the holds submitted by these drivers by dispatching parking enforcement personnel to issue citations at these parking spaces if occupied and/or by issuing notifications to vehicle accounts linked to vehicles occupying these parking spaces near or during time windows specified by these holds.

The method S100 is described herein as executed by the computer system in conjunction with sensor units and vehicle transmitters to automatically enforce parking rules at restricted parking spaces, such as loading zones and freight parking spaces. However, Blocks of the method S100 can be executed by any other local or remote computing device to enforce parking rules in parking lots, for prioritized or reserved parking spaces, or for any other type of public, private, on-street, parking garage, or other parking type.

### 3. Sensor Unit

In one implementation, a sensor unit can include: a proximity sensor configured to detect a (large) mass overhead, such as an engine block, a motor, or a battery pack; a communication module configured to broadcast a query, to receive a vehicle identifier from a vehicle transmitter in a vehicle parked overhead, and to transmit (e.g., wirelessly) a status update and the vehicle identifier to the computing device; and a power supply (e.g., a battery). The sensor unit is configured to be installed below (e.g., “buried under”) a parking space.

However, the sensor unit: can include any other sensor, communication, or power elements; can communicate with the computer system over wired or wireless communication protocols; can be powered via an onboard or connected battery or other power supply; and can be installed under, overhead, or adjacent a parking space.

### 4. Vehicle Transmitter

In one implementation, a vehicle transmitter: is preloaded with a unique vehicle identifier; includes a passive wireless transmitter powered by a query broadcast by a nearby sensor unit; and broadcasts the vehicle identifier when powered by an inbound query. Alternatively, the vehicle transmitter can include a battery or is configured to connect to a power supply of a vehicle.

The vehicle transmitter can be installed (intransiently) on a vehicle, such as: on a license plate surround; on a windshield; or on a framerail of the vehicle. Alternatively, the vehicle transmitter can be integrated into a fob configured to connect to a keychain or to be stored in a glovebox.

However, the vehicle transmitter can define any other format and can be installed on or stored in a vehicle in any other way.

### 5. Setup and Onboarding

In one implementation, a vehicle authorized to park in loading zones, freight parking zones, restricted parking spaces in a parking lot, (e.g., executive, guest, employee parking spaces), and/or other parking spaces within a geographic region or on a campus, etc. is issued a vehicle transmitter, which is (permanently) installed in or on this vehicle.

In this implementation, a vehicle account is activated for an operator, owner, or other affiliate of the vehicle, and the vehicle identifier stored in the vehicle transmitter is linked to the vehicle account. Furthermore, payment and contact methods are linked to this vehicle account.

For example a vehicle account can be activated for a fleet of delivery vehicles; vehicle identifiers for each vehicle in this fleet can be linked to this vehicle account; a payment method can be linked to this vehicle account to cover parking fees for future use of restricted parking spaces by these delivery vehicles; and contact information for a dispatcher for this fleet is connected to the vehicle account, thereby completing setup for the fleet.

In one variation, a vehicle account is activated for an entity hosting guests, employees, occupants, etc. necessitating occasional access to a loading zone, freight parking space, or other restricted parking space, such as an apartment complex local business. In this variation, a “floating” vehicle transmitter is configured to and temporarily allocated to a guest, employee, or occupant, etc., who may place the floating vehicle transmitter in her vehicle and thus access a restricted parking space nearby. For example, a floating vehicle transmitter can be issued to an apartment complex. When a new occupant moves into the apartment complex, an apartment complex manager may provide the floating vehicle transmitter to the new occupant, who places the floating vehicle transmitter in her car and parks her car in a restricted parking space near the apartment complex while unloading personal items from her car. Similarly, when this occupant moves out of the apartment complex, the apartment complex manager may again provide the floating vehicle transmitter to the new occupant, who places the floating vehicle transmitter in her car and parks her car in this restricted parking space near the apartment complex while loading personal items back into her car.

### 6. Parking Space Status

Once deployed under a parking space, a sensor unit actively or passively senses entry of a vehicle into the parking space overhead, such as based on a change in overhead capacitance, a change in overhead load, overhead motion, or another vehicle presence trigger. In response to detecting this vehicle presence trigger, the sensor unit broadcasts a query for a vehicle identifier.

If the vehicle overhead is equipped with a vehicle transmitter, the vehicle transmitter returns its preloaded vehicle identifier to the sensor unit. Upon receiving this vehicle identifier, the sensor unit transmits an “occupied” status, the vehicle identifier, and its assigned sensor unit identifier to the computer system to confirm occupancy of the parking space.

Conversely, if the sensor unit fails to receive a vehicle identifier within a threshold duration of broadcasting the query (and after broadcasting multiple repeated queries for the vehicle identifier), the sensor unit can transmit an “occupied” status, an invalid vehicle flag, and the sensor unit identifier to the computer system.

### 7. Parking Space Status Monitoring

After detecting a vehicle occupying the parking space overhead, the sensor unit can regularly transmit queries for a vehicle transmitter and actively or passively scan for a change in presence of an (large) overhead mass (e.g., based on a return to a baseline capacitance range or to a baseline overhead load range), such as once per minute while the sensor unit detects that the parking space is occupied.

If the sensor unit receives a vehicle identifier responsive to its query after initially detecting occupancy of the parking space, the sensor unit can also: write this vehicle identifier to local memory; verify that this same vehicle identifier was received responsive to subsequent queries broadcast by the sensor unit; detect exit of this vehicle from the parking space and occupancy of this particular parking space by a different vehicle if the sensor unit continues to identify the parking space as occupied but receives no vehicle identifier or a different vehicle identifier responsive to subsequent queries. The sensor unit can thus return a status change for the parking space to the computer system responsive to a change in vehicle identifier returned by a vehicle overhead or in response to detecting absence of a vehicle overhead.

For example, in response to continuing to detect an (large) overhead mass but receiving a different vehicle identifier, the sensor unit can transmit an occupied status, a vehicle identifier change flag, and the new vehicle identifier to the computer system. In this example, in response to continuing to detect an (large) overhead mass but receiving no vehicle identifier, the sensor unit can transmit an occupied status, a vehicle identifier change flag, and an invalid vehicle flag to the computer system. Furthermore, responsive to detecting absence of an (large) overhead mass, the sensor unit can transmit an unoccupied status to the computer system.

### 8. Variation: Time Synchronization

In one variation, when the vehicle transmitter receives a query from a sensor unit below the parking space occupied by the vehicle, the vehicle transmitter can retrieve a current time and transmit both this current time and the vehicle identifier to the sensor unit. The sensor unit can then update an internal clock according to the current time received from the vehicle transmitter and transmit an “occupied” status, the vehicle identifier, and the current time to the computer system. The computer system can then log the entry time of the vehicle based on the time received from the sensor unit (such as rather than logging the time of receipt of the change in status from the sensor unit as the entry time of the vehicle at the parking space).

### 9. Variation: Power Management

In another variation, to reduce occurrence of data transmission by the sensor unit to the computer system, and thus reduce power consumption and increase battery life of the sensor unit, the sensor unit transmits queries including its unique sensor unit identifier. When a vehicle transmitter receives this query from the sensor unit upon entering the parking space, the vehicle transmitter: transmits an “occupied” status, the current time, the sensor unit identifier, and the vehicle identifier to the computer system, which logs the status update for the parking space, as described above; and returns confirmation of the status update for the parking space to the sensor unit, which withholds transmission of these data to the computer system.

### 10. Occupied Status

Upon receipt of an “occupied” status change from the sensor unit, the computer system can: identify the particular parking space based on the sensor unit identifier; update the status of the particular parking space in a parking space log with the “occupied” status at the time of receipt of the status update from the sensor unit; and generate a new parking event record for the parking space.

If the sensor unit also returned a vehicle identifier, the computer system can query a vehicle database for a vehicle account associated with the vehicle identifier.

### 10.1 Authorized Vehicle Identifier Linked to Current Vehicle Account

In one implementation, if the vehicle identifier is listed in the vehicle database and is linked to a valid and current vehicle account, the computer system can: write the vehicle identifier to the parking event record; and link the vehicle account (or a billing method connected to the vehicle account) to the parking event record.

### 10.1.1 Parking Time Limit

The computer system can also retrieve a parking time limit for the particular parking space, such as from a parking rule database, and initiate a parking time limit timer for the parking time limit. While the parking time limit timer is active, the computer system can label the parking event record as “validated.”

Then, if the parking time limit timer expires prior to receipt of a status change from the sensor unit indicating exit of the vehicle from the parking space, the computer system can: relabel the parking event record as “invalidated, time limit expired.” If the parking time limit timer expires prior to receipt of this status change from the sensor unit, the computer system can also: generate a citation specifying the vehicle identifier; and queue transmission of the citation to the particular vehicle account (or to an address or recipient specified in the particular vehicle account).

Alternatively, the computer system can: retrieve an extended parking time rate for time limit overages at the parking space, such as specified in the parking rule database; add an additional fee to billing for the vehicle occupying the parking space based on the extended parking time rate; and reflect this updated billing to the parking event record. For example, the computer system can: calculate an overage duration from expiration of the parking time limit timer to receipt of a status change from the sensor unit indicating exit of the vehicle from the parking space; multiply this overage duration by the extended parking time rate; and add this value to a parking fee—for occupation of the parking space by the vehicle beyond the parking time limit posted at this parking space—recorded in the parking event record.

### 10.1.2 Billing Period

Furthermore, if the parking rule database specifies a parking rate for occupying the parking space during the parking time limit, the computer system can initiate a billing clock at the time of receipt of the change in status of the parking space to “occupied” by the vehicle and link the billing clock to the parking event record. Upon receipt of a status change from the sensor unit indicating exit of the vehicle from the parking space, the computer system can: stop the billing clock; multiply the time on the billing clock by the parking rate; and add this value to a parking fee—for occupation of the parking space during the parking time limit for this parking space—recorded in the parking event record.

### 10.1.3 Grace Period

In this implementation, if a grace period is designated for the parking space in the parking rule database, the computer system can label the parking event record as “validated, in grace period” and initiate a grace period timer for a preset grace period duration upon receipt of the vehicle identifier and status change from the sensor unit. Then, if the grace period timer expires prior to receipt of a status change from the sensor unit indicating exit of the vehicle from the parking space, the computer system can initiate the billing clock described above and relabel the parking event record as “validated, in billing period.”

For example, the parking rule database can specify a 5-minute grace period in which a vehicle is permitted to occupy the space without payment or risk of citation. If the computer system validates the vehicle identifier received from the sensor unit and confirms the affiliated vehicle account, the computer system can thus delay activation of the billing timer until the grace period timer expires, thereby automatically executing billing rules defined in the parking rule database (and incentivizing exit from the parking space before conclusion of the grace period).

### 10.1.4 Vehicle Account Notification

Furthermore, upon identifying the vehicle now occupying the parking space, the computer system can transmit a notification to the affiliated vehicle account (e.g., to recipient specified in the user account, such as a vehicle dispatcher) confirming detection and identification of the vehicle at the parking space.

For example, upon identifying the vehicle occupying the space based on a vehicle identifier and a sensor unit identifier received from the sensor unit, the computer system can generate a notification including: a vehicle registration number or vehicle “nickname” linked to the vehicle identifier in the vehicle database or specified in the user account; an identifier (e.g., a number) and a geospatial location of the parking space; a time that the vehicle was first detected at the parking space; and parking rules associated with the parking space. The computer system can then transmit this notification to a recipient designated in the user account. Alternatively, the computer system can update a user portal—such as within a web browser or native application—linked to this user account to reflect these parking-related data for the vehicle.

The computer system can also transmit status updates and/or update the user portal to reflect changes in status of the vehicle, such as: when the vehicle transitions out of grace period and into a billing period; when the parking time limit expires and the vehicle transitions into an “invalidated, time limit expired” status; when a citation is issued to the vehicle; and/or when an extended parking time limit fee is activated for the vehicle.

10.1.5 Authorized Vehicle Exit from Parking Space

Finally, upon detecting that the vehicle has exited the parking space (e.g., if the sensor unit at the parking space no longer detects a large overhead mass and/or fails to receive the vehicle transmitter from the vehicle responsive to subsequent queries broadcast by the sensor unit), the computer system can: calculate a final parking fee for occupation of the parking space by the vehicle; write the final parking fee to the parking event record; automatically bill the stored payment method linked to the vehicle account according to this final parking fee; and/or transmit a status update or update the user portal to reflect exit of the vehicle from the parking space.

### 10.2 Authorized Vehicle Identifier Linked to Out-of-Date Vehicle Account

Alternatively, if the vehicle identifier received from the sensor unit—with a change in status of the parking space to “occupied”—is listed in the vehicle database but is linked to an expired vehicle registration within the vehicle database or is linked to an out-of-date vehicle account (e.g., an expired vehicle account, a vehicle account with an expired payment method), the computer system can label the parking event record as “invalid, unauthorized account.” The computer system can then: add this parking space to a citation queue for issuance of a physical citation by parking enforcement personnel; or generate an electronic citation specifying the vehicle identifier and the affiliated vehicle account and queue this electronic citation for transmission to the affiliated vehicle account.

Alternatively, if a grace period is designated for the parking space, the computer system can: label the parking event record as “grace period, unauthorized account” and initiate a grace period timer for the preset grace period duration. If the sensor unit fails to return a change in status indicating exit of the vehicle from the parking space prior to expiration of the grace period timer, the computer system can: relabel the parking event record as “invalid, unauthorized account”; and add this parking space to the citation queue or serve an electronic citation for the vehicle to the affiliated vehicle account, as described above.

Furthermore, despite the expired status of the vehicle identifier or the affiliated vehicle account, the computer system can implement methods and techniques described above to transmit a notification to a recipient specified in the affiliated vehicle account or update a user portal linked to the affiliated vehicle account to: indicate that the invalid vehicle was detected in the parking space; request that the vehicle be removed from the parking space; and/or indicate a citation status of the vehicle (e.g., “invalid, in grace period,” “invalid, citation pending,” or “invalid, citation issued”).

### 10.3 Status Refinement: Invalid or Absent Vehicle Identifier

Alternatively, if the vehicle identifier received from the sensor unit—with a change in status of the parking space to “occupied”—is not listed in the vehicle and therefore not registered in the parking system, the computer system can label the parking event record “invalid, unknown vehicle.”

Similarly, if the sensor unit fails to return a vehicle identifier to the computer system with a change in status of the parking space to “occupied,” the computer system can label the parking event record as “invalid, unknown vehicle.”

The computer system can also: initiate a grace period timer for the parking space, as described above; and then flag the parking space for manual inspection and issuance of a parking citation after expiration of the grace period time.

### 11. Parking Space Map

In one variation, the computer system also populates a map of parking spaces within a geographic region with real-time statuses of these parking spaces and serves this map to users (e.g., delivery personnel, truck drivers, vehicle dispatchers)—such as through native applications or web browsers executing on their mobile devices (e.g., smartphones)—to enable these users to monitor and identify available parking spaces near their designated delivery and pickup locations.

### 11.1 Parking Space Status

In one implementation, the computer system maintains a map of parking spaces—equipped with sensor units—within a geographic region (e.g., a city, township) by labeling each parking space representation in the map with a current status of the corresponding parking space in the geographic region. For example, the computer system can render textual “occupied” and “unoccupied” labels over parking space representations—in the map—corresponding to occupied and unoccupied parking spaces, respectively. In another example, the computer system renders a “green” overlay and a “red” overlay over parking space representations—in the map—corresponding to occupied and unoccupied parking spaces, respectively.

Therefore, the computer system can enable a user to quickly visually identify parking spaces that are currently available in the geographic region—such as near a next delivery or pickup location to which the user is currently en route—by viewing the map through her smartphone, tablet, or other mobile device.

### 11.2 Status Change Time

In this variation, for each “occupied” parking space represented in the map, the computer system can also label the corresponding parking space representation with a status (e.g., a remaining time value) of the parking time limit timer assigned to the parking space. For example, the computer system can render a virtual digital or virtual analog clock over a representation of a corresponding “occupied” parking space in the map. In another example, the computer system can mask this parking space representation with a color code based on the status of the corresponding parking time limit time, such as including: a “red” overlay if a large amount of time remains on the parking time limit timer (e.g., more than 20 minutes for a 30-minute parking time limit) of a corresponding “occupied” parking space; an “orange” overlay if a moderate amount of time remains on a parking time limit timer (e.g., between five and 20 minutes for a 30-minute parking time limit) of a corresponding “occupied” parking space; a “yellow” overlay if a minimal amount of time remains on a parking time limit timer (e.g., less than five minutes for a 30-minute parking time limit) of a corresponding “occupied” parking space; and a “green” overlay for a corresponding “unoccupied” parking space.

In this implementation, the computer system can thus enable a user to quickly predict when occupied parking spaces may become available by reviewing the map (e.g., based on an assumption that vehicles occupying these parking spaces will abide by parking time limits).

### 11.3 Parking Space Occupation Change Prediction

Generally, a vehicle with valid vehicle identifiers paired with valid vehicle accounts may be more likely to fulfill parking time limits than vehicles within valid vehicle identifiers (i.e., invalid vehicles) and vehicles without vehicle transmitters (i.e., unauthorized vehicles, such as passenger vehicles). Therefore, in this variation, the computer system can also annotate parking space representations of occupied parking spaces in the map to reflect: greater confidence that parking spaces occupied by registered vehicles will become available upon or before expiration of corresponding parking time limit timers; and lower confidence that parking spaces occupied by unregistered and unknown vehicles will become available upon or before expiration of corresponding parking time limit timers (e.g., due to lesser predictability of parking behaviors of unauthorized, invalid vehicles).

For example, the computer system can: render color masks reflecting occupancy of parking spaces by registered vehicles with high opacity (i.e., low translucence); and render color masks reflecting occupancy of parking spaces by unregistered an unauthorized vehicles with low opacity (i.e., high translucence).

### 12. Parking Space Holds and Reservations

In one variation, a user portal with a native application or web browser executing on a user's computer system presents the map to the user and interfaces with the user (e.g., a driver or a vehicle dispatcher) to: select a particular parking space from the map; define a hold time window (e.g., a 15-minute hold time window) in which the user intends to enter the particular parking space; specify the vehicle (e.g., by entering a registration number or by selecting the vehicle from a set of vehicles linked to the affiliated vehicle account); and submit a new hold request for this particular parking space during this hold time window.

In this variation, upon receipt of a hold request, the computer system can verify that the new hold request is valid, such as: if no hold previously submitted specifies the same parking space and a hold time window that intersects the hold time window of this new hold request; and if a no parking time limit timer for the particular parking space is due to expire after the start of the hold time window specified in the new hold request. (The user portal can additionally or alternatively filter parking spaces available for hold requests based on these parking space statuses.)

Then, if the computer system confirms that the hold request is valid, the computer system can: notify the user that the hold is confirmed; update the map to indicate that the parking space is occupied or otherwise not available to any other vehicle during the hold time window specified in the hold request; retrieve a particular vehicle identifier of the user's vehicle; and write a flag to validate detection of the particular vehicle identifier—specified in the hold request—at the particular parking space during the hold time window and to invalidate all other vehicles and vehicle identifiers detected at the particular parking space during the hold time window.

Furthermore, the computer system can update the representation of the particular parking space in the map to indicate that the particular parking space is occupied (or reserved, on hold) throughout the duration of the hold time window, such as regardless of whether the particular vehicle identifier is received at the sensor unit during this hold time window, thereby enabling other users to ascertain that the particular parking space is not available during the hold time window—even if the particular parking space is unoccupied—by reviewing the status of the parking space in the map.

### 12.1 Parking Space Occupied by Authorized Vehicle Before Hold Window

Then, if the sensor unit and the computer system detect and identify a second vehicle entering the particular parking space prior to the start of the hold time window and the parking time limit for the particular parking space extends—from entry of the second vehicle into the particular parking space—into the hold time window of the hold on the particular parking space, the computer system can transmit a notification to a second vehicle account associated with the second vehicle or update a user portal linked to this second vehicle account to indicate that the second vehicle will enter an invalid status and may be subject to a citation if still occupying the particular parking space by the start time of the hold time window.

In this scenario, the computer system can also transmit a notification to the user portal—of the user linked to the hold request—indicating that the hold for the particular parking space is at risk due to presence of the second vehicle in the particular parking space. The computer system can also: enable the user to delay the hold time window, such as by five minutes via the user portal, responsive to presence of the second vehicle in the particular parking space at a time near the start of the hold time window; and then update the hold request, withhold or delay issuance of a citation, and/or update the validity status of the particular parking space and the second vehicle accordingly.

### 12.2 Parking Space Occupied by Authorized Vehicle During Hold Window

In the foregoing scenario, once the current time enters the hold time window, the computer system can automatically: issue a citation to the second vehicle if the second vehicle is still present in the particular parking space; and/or generate a notice indicating that the second vehicle is in violation of a parking space hold and transmit this notice to the second vehicle account.

Alternatively, if the second vehicle is still present in the particular parking space once the current time enters the hold time window, the computer system can: withhold issuance of a citation to the second vehicle; activate an option at the user portal of the user affiliated with the hold request to either a) confirm issuance of the citation to the second vehicle or b) cede the particular parking space to the second vehicle and thus cancel the citation; and selectively issue or withhold a citation to the second vehicle accordingly.

### 12.3 Parking Space Occupied by Unauthorized Vehicle During Hold Window

In a similar scenario, if the sensor unit and the computer system detect an unregistered or unauthorized second vehicle occupying the particular parking space prior to and within a threshold duration of the start of the hold time window, the computer system can: transmit a notification to the user affiliated with the hold request indicating that the hold for the particular parking space is at risk due to presence of the second vehicle in the particular parking space. The computer system can also: interface with the user via the user portal to delay the hold time window, such as by five minutes; and/or queue the particular parking space for review and issuance of a citation by parking enforcement personnel.

### 13. Parking Monitor

In one variation, the computer system generates or queues issuance of parking citations: for unregistered and unauthorized vehicles occupying parking spaces—restricted to vehicles equipped with vehicle transmitters—for durations of time exceeding grace periods assigned to these parking spaces; and for vehicles equipped with vehicle transmitters but linked to out-of-date vehicle accounts or vehicle identifiers and occupying these parking spaces for durations of time exceeding grace periods assigned to these parking spaces; for registered and authorized vehicles linked to current vehicle accounts and occupying these parking spaces for durations of time exceeding parking time limits assigned to these parking spaces; and/or for vehicles improperly occupying parking spaces during hold time windows specified in hold requests submitted for other vehicle identifiers.

### 13.1 Citation Priority

The computer system can also calculate priorities for these citations. In one example, the computer system: assigns greatest scores (e.g., priorities) to citations for vehicles occupying parking spaces during hold windows; next-highest scores to citations for parking spaces occupied by unregistered and unknown vehicles; next-highest scores to registered vehicles occupying parking spaces beyond parking time limits; etc.

In this example, the computer system can also dynamically adjust the score (i.e., priority) of a citation as a function of (e.g., proportional to) a duration that a corresponding parking space has been occupied beyond a grace period duration or beyond a parking time limit.

Furthermore, in this example, the computer system can: score citations for unregistered and unknown vehicles only and queue these citations for physical issuance by parking enforcement personnel; and queue mailing of paper or electronic citations to vehicle accounts associated with vehicle transmitter-equipped vehicles that failed to adhere to parking rules specified in the parking rule database.

### 13.2 Citation Update

The computer system can also monitor a status of a parking space once a issuance of citation is designated for a vehicle occupying the parking space and adjust the citation accordingly. For example, for a parking space flagged for issuance of a citation to an unknown vehicle occupying the parking space for greater than the grace period duration, the computer system can immediately close and cancel issuance of this citation if the citation has not yet been issued by parking enforcement personnel once the sensor unit at this parking space indicates that the vehicle has left the parking space. In this example, the computer system can: similarly cancel issuance of a citation to a registered vehicle once the sensor unit at a parking space indicates that this vehicle has exited the parking space; and instead queue mailing of a paper citation to a vehicle account associated with this registered vehicle and/or queue issuance of an electronic citation to this vehicle account.

### 13.2 Parking Enforcement Support

In one implementation, the computer system interfaces with a parking monitor unit installed or located within a parking enforcement vehicle and including: a wireless communication module; a geospatial location sensor; a citation printer; and a display (or a communication module configured to interface with an external display).

In this implementation, the computer system can: track the location of the parking monitor unit based on geospatial location data received from the parking monitor unit; calculate a path for the parking monitor unit that routes the parking monitor unit along a sequence of parking spaces characterized by a greatest sum in parking space scores per unit distance traversed; and transmit this path to the parking monitor unit for presentation to parking enforcement personnel operating the parking enforcement vehicle. Then, as the parking monitor unit approaches a target parking space flagged for issuance of a citation, the computer system can: transmit citation data for this citation to the parking monitor unit (e.g., including vehicle registration data for a registered vehicle; excluding vehicle registration data for an unregistered vehicle); and queue the parking monitor unit to print the citation. The parking monitor unit can also output a visual and/or audible prompt indicating proximity of the target parking space. Parking enforcement personnel may then stop the parking enforcement vehicle, manually complete the printed citation, and present the citation to the vehicle occupying this parking space.

In another implementation, the computer system implements methods and techniques similar to those described above: to annotate a map of parking spaces in the geographic region with citation statuses and citation scores of these parking spaces; and to serve this citation map to parking enforcement personnel through the parking monitor unit, through a native application or web browser executing on a mobile device carried by parking enforcement personnel or located in the parking enforcement vehicle, or through any other display or portal accessible to parking enforcement personnel. Parking enforcement personnel may then elect a route along these parking spaces according to this citation map and issue physical citations to vehicles occupying these parking spaces accordingly.

### 13.3 Double Parking

In one variation, if a sensor unit receives two vehicle identifiers responsive to a query broadcast by the sensor unit, the sensor unit can return these two vehicle identifiers to the computer system. The computer system can then: interpret these two concurrent vehicle identifiers as an instance of double parking adjacent a parking space associated with the sensor unit identifier received from this sensor unit; assign a high(est) score (e.g., a high(est) priority) to this parking space; and dispatch parking enforcement personnel to this parking space, such as to issue a citation to a double-parked vehicle adjacent this parking space.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for managing restricted parking spaces comprises:
at a sensor unit located under a parking space:
in response to detecting an overhead mass,
broadcasting a query; and
transmitting a status update for occupancy of the parking space to a computer system; and
in response to receiving a vehicle identifier from a vehicle transmitter responsive to broadcasting the query, transmitting the vehicle identifier to the computer system;
at the computer system:
in response to receiving the status update for occupancy of the parking space
updating a representation of the parking space in parking space map according to the status update for occupancy of the parking space;
in response to receiving the vehicle identifier from the sensor unit
identifying a vehicle account associated with the vehicle identifier;
retrieving a parking time limit assigned to the parking space;
initiating a parking timer for the parking time limit; and
in response to expiration of the parking timer prior to receipt of a status update for availability of the parking space from the sensor unit, transmitting a notification for parking infringement by a vehicle associated with the vehicle identifier to the vehicle account; and
in response to absence of a receipt of the vehicle identifier from the sensor unit
retrieving a grace period duration assigned to the parking space;
initiating a grace period timer for the grace period duration; and
in response to expiration of the grace period timer prior to receipt of a status update for availability of the parking space from the sensor unit, dispatching a parking enforcement person to issue a citation at the parking space.
